(19) United States
(12) Patent Application Publication
(10) Pub. No.: US 2004/0128617 A1
(43) Pub. Date: Jul. 1, 2004

(54) Transmission method for XML-based EPG for a user-preference program guide and reception device

(76) Inventor: Keum-Yong Oh, Suwon-si (KR)

Correspondence Address: Peter L. Kendall, Roylance, Abrams, Berdo & Goodman, L.L.P., Suite 600, 1300 19th Street, N.W., Washigton, DC, 20036, US

(21) Appl. No.: 10/658,334

(22) Filed: Sep. 10, 2003

(30) Foreign Application Priority Data
Dec. 27, 2002 (KR) 2002-85446

(51) Int. Cl. G06F 17/00

(52) U.S. Cl. 715/513

(57) ABSTRACT

A method for transmitting an extensible markup language (XML)-based electronic program guide (EPG) template for a user-preference program guide and a reception device thereof, are provided. The transmission method includes a cable network company converting an XML-based EPG into an XML-based EPG template for a user-preference program guide, transmitting the converted result to a reception device, and providing the reception device with a style format related to the XML-based EPG template document through an extensible style sheet language (XSL)-based document. The reception device stores and analyzes the XSL document related to the XML-based EPG template document.

### PRIORITY

This application claims priority from Korean Patent Application No. 2002-85446 filed on Dec. 27, 2002, in the Korean Intellectual Property Office, the disclosure of which is incorporated herein by reference in its entirety.

### BACKGROUND OF THE INVENTION

1. Field of the Invention

The present invention relates to a method for transmitting an electronic program guide (EPG) and a reception device thereof, and more particularly, to a method for transmitting an extensible markup language (XML)-based EPG template for a user-preference program guide and a reception device thereof.

2. Description of the Related Art

Digital broadcasting systems capable of receiving television signals via cable broadcasting have recently been widely distributed. Since digital broadcasting can provide a large number of channels, a large number of programs can be broadcast, in comparison with terrestrial wave broadcasting systems. Digital broadcasting includes a large amount of broadcasting program information that is transmitted via an electronic program guide (EPG) that allows users to select and view desired programs. However, the large amount of broadcasting program information makes it difficult to search for or classify programs.

In conventional EPG transmission and reception systems, a cable network company produces programs and a program guide for viewers to peruse. Here, EPG information is displayed differently according to a receiver manufacturer (e.g. cable box) or a class of a receiver. To solve this problem, EPGs have been produced using an extensible markup language (XML). However, XML-based EPGs force users to conduct unnecessary searches through large amounts of program information, and limit a screen configuration to only a script language contained in the XML-based EPG itself.

Also, having a large number of programs, increases the size of a program guide and thereby causes difficulties for the program guide producer and the receiver manufacturer. Even if an XML is used to solve this problem, a simple XML document imposes on users the burden of perusing through program guide information in detail or performing a sequence of steps using a provided search tool in order to find and register their preferred programs. Also, it is difficult for a user to configure a screen as the user desires because a program guide can only be displayed on the screen in a script language contained in an XML document.

Korean published Patent Publication No. 2001-87373, which is the basis of PCT International Patent Application No. PCT/JP2000/0558 (PCT International published Publication No. WO 2001/15444) entitled “Transmission Method and Reception Apparatus”, discloses a conventional method and apparatus for transmitting and receiving an EPG. The disclosed method and apparatus enable easy searching for programs broadcast over many channels as in a digital TV broadcasting system, and reduce a number of development processes. The transmission method involves producing program guide data including a control signal for controlling a display form when the program guide information is displayed on a display device, and transmitting the program guide data together with video and audio signals. Also, the reception apparatus receives a broadcasting signal including the program guide data and video and audio signals. The reception apparatus includes a receiver that receives the broadcasting signal, an extractor that extracts the program guide data from the received broadcasting signal, and a display processor that processes the program guide data based on the included control signal. Accordingly, since an EPG is written in XML, and a broadcasting station or a contents producer inserts characters, images or sounds into the program guide data, a variety of display modes are possible and the EPG is relatively easier for a user to manipulate. However, it is still not possible for a user to obtain and organize program guide information that matches his/her preferences through simple manipulation.

Since several hundred program services are possible in the case of cable broadcasting, users can only either view programs one-by-one in an order that is not of their choosing or conduct lengthy searches to locate programs. Furthermore, size difference among displays is a source of difficulty for service producers, and thus production of service programs without consideration of the size of the display can result in a screen configuration not matching a user's preference.

### SUMMARY OF THE INVENTION

The present invention provides a method of transmitting an electronic program guide that reflects a user's preferences, and a reception apparatus thereof, in which an XML-based EPG template is produced according to a user's preference based on an existing XML-based EPG, to thus enable the selection of program guide information without having to peruse unnecessary information.

The present invention also provides a method of transmitting an electronic program guide that reflects a user's preferences, and a reception apparatus thereof, in which an XML-based EPG template is converted into an extensible stylesheet language (XSL), and thus a user's program guide is registered and modified through a variety of information displays, using the XSL.

The present invention also provides a method of transmitting an electronic program guide that reflects a user's preferences, and a reception apparatus thereof, in which program guide information is written in XML, the program guide information is made into an XML-based EPG template through a user's preference standard such as a program feature, or a user's age and taste. The program guide information is primarily, selectively transmitted through the XML-based EPG template, so that a user does not have to peruse unnecessary information, and the XML-based EPG template is converted into an extensible stylesheet language (XSL), so that a more specific user's program guide can be registered or modified.

To accomplish the above object of the present invention, there is provided a method for transmitting a program guide, comprising the steps of: converting an extensible markup language (XML)-based electronic program guide (EPG) into an XML-based EPG template for a user's preferred program guide at a cable network company, and transmitting the XML-based EPG template to a receiver.

Preferably, the cable network company provides a style form related to the XML-based EPG template for the receiver, through conversion into an extensible stylesheet language (XSL) document.

Preferably, the receiver stores and analyzes the XSL document related to the XML-based EPG template document.

According to another embodiment of the present invention, there is provided a reception apparatus that receives a program guide transmitted from a cable network company, the reception apparatus comprising: a storage unit that stores an extensible markup language (XML)-based electronic program guide (EPG) template document for a user's preferred program guide which has been converted and transmitted from a cable network company; an XML parser that parses the stored XML-based EPG template document; and a graphics processor for graphically processing the parsed XML document and displaying the graphically processed result on a display.

Preferably, the reception apparatus further comprises: a storage unit that stores an extensible stylesheet language (XSL) document related to the XML-based EPG template document; and an XSL processor that processes the stored XSL document.

Preferably, the graphics processor processes the parsed XML-based EPG template document and the XSL document so that extracted EPG-related data and display-related information is displayed on the display.

Preferably, the reception apparatus further comprises a storage unit that stores and manages various XSL documents defined by a user and related to the same XML-based EPG template document.

### BRIEF DESCRIPTION OF THE DRAWINGS

The above and other objects and advantages of the present invention will become more apparent by describing embodiments thereof in detail with reference to the accompanying drawings in which:

FIG. 1 is a block diagram illustrating an example of an extensible style sheet language (XSL) conversion according to an embodiment of the present invention;

FIG. 2 is a block diagram illustrating an example of transmission and reception of an extensible markup language (XML) template document and a related XSL document according to an embodiment of the present invention;

FIG. 3 is a block diagram illustrating an example of transmission and reception of an extensible markup language template document and a conversion process into an XSL document according to an embodiment of the present invention;

FIG. 4 is a block diagram illustrating an example of processing an extensible markup language template document and an XSL document for a display according to the present invention;

FIG. 5 is a block diagram illustrating an example of producing an extensible markup language template document and a step of storing an XSL document according to an embodiment of the present invention; and

FIG. 6 is a block diagram illustrating an example of a variety of display structures of an extensible markup language template document through an XSL document according to an embodiment of the present invention.

### DETAILED DESCRIPTION OF THE PREFERRED EMBODIMENTS

A method for transmitting an electronic program guide that reflects a user's preferences, and a reception apparatus thereof, according to embodiments of the present invention will be described with reference to the accompanying drawings. This will begin with a description of an extensible markup language (XML) applied in the present invention.

XML was recommended by W3S in 1998. XML is a structural language designed on the basis of data exchange and enables easy searching based on a tree structure. Also, XML describes the structure of a document through a document type definition (DTD) determined by a user. XML is currently used in many fields in which large amounts of data are integrated and managed, and the scope of its use is constantly growing.

Data related to programs possess similar attributes. Basically, data such as a program start time, a program end time, and a program title, become essential elements and are stored as XML document data. Further, data is classified according to a program feature. A program can possess different data according to a classification feature. As an example, in the case of a news program, a node for an event and a subordinate node for a report in charge can be created. Also, in the case of a weather program, local temperatures, high and low temperatures, etc., can be created as subordinate nodes. Also, in the case of an entertainment program, an event node can be created. Aside from these examples, various other involved nodes can be created. As such, a single XML document including the various necessary involved nodes can be created according to a program feature and a viewer's feature. Such a document is called an XML template document.

A program guide list provided from a cable network company according to the present invention can be configured by reflecting program information, or a user's age or taste thereon. That is, the program guide list according to an embodiment of the present invention provides an XML-based EPG template document and an XSL document capable of configuring a style sheet related to the EPG document. Also, an extensible path (XPath) can access a subordinate node in different XML template documents, through another document, and can configure a personalized program guide list that reflects a user's taste.

A cable network company transmits a document corresponding to a user via confirmation of a user's information among XML-based template documents by considering features of services or programs, viewing times of services or programs, and ages and various tastes of viewers, etc. A user receives the document via a receiver, and analyzes it with an analyzer including an XML parser. The received XML-based EPG template document is used as a primary profile for a user, through which the user can filter a large amount of program guide information data. The cable network company transmits an XSL document simultaneously so that data of the XML document can be displayed according to a user's preferences. The receiver parses the XML template document and displays data through a graphics engine according to the description in the XSL document via an XSL converter located in a processor. Here, the XSL document helps a function of a secondary profile.

Hereinafter, XSL and XPath will be described in detail.

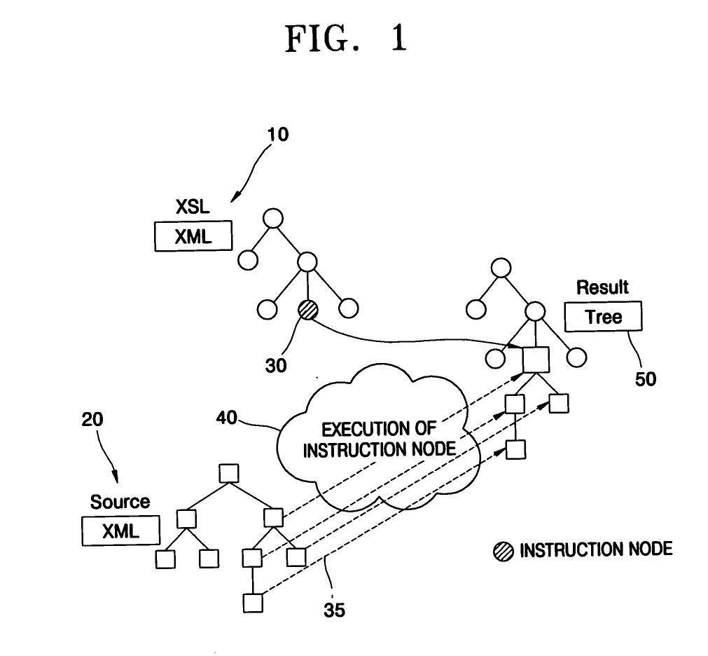

Referring to FIG. 1, an XSL style sheet 10 includes a rule including a single-path tree. An instruction node 30 gains access to a node that is a part of an input tree 20, being an XML document, when processing an XPath expression. Based on the rule, a new result tree is created as a single-path tree according to processing of another instruction node. A special merging process 40 is performed on XML-based EPG template documents by using the XSL conversion technology. It is possible to access a particular node in each document by using XSL 10 and XPath 35 without having to make a new XML document through the merging process and configure a new single tree 50 by collecting the accessed nodes. That is, a viewer can register and delete his or her desired program information list from his or her selected XML-based EPG template document provided from the cable network company, by using XSL.

A first step (Phase 1) of distribution of the XML template document from a cable network company, and the related XSL document, will be described below.

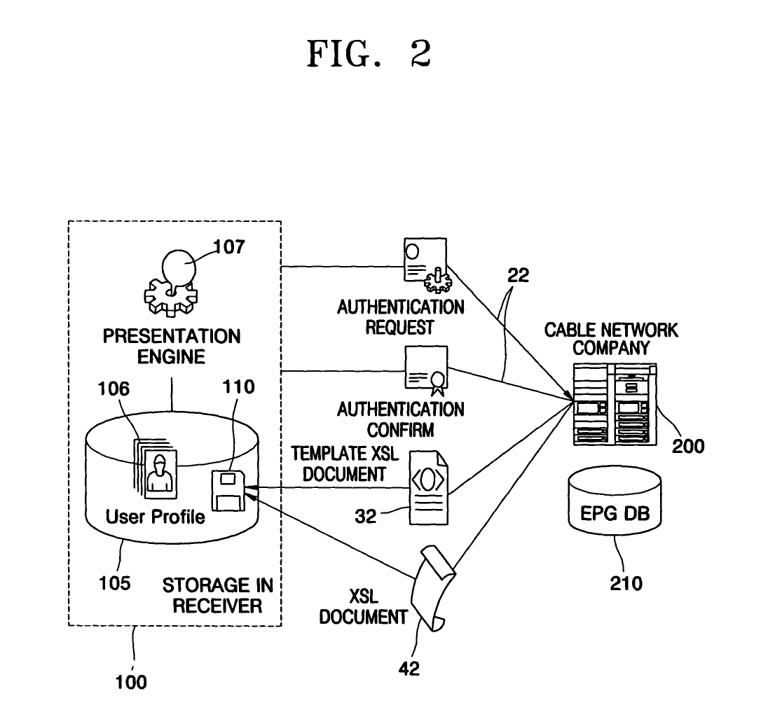

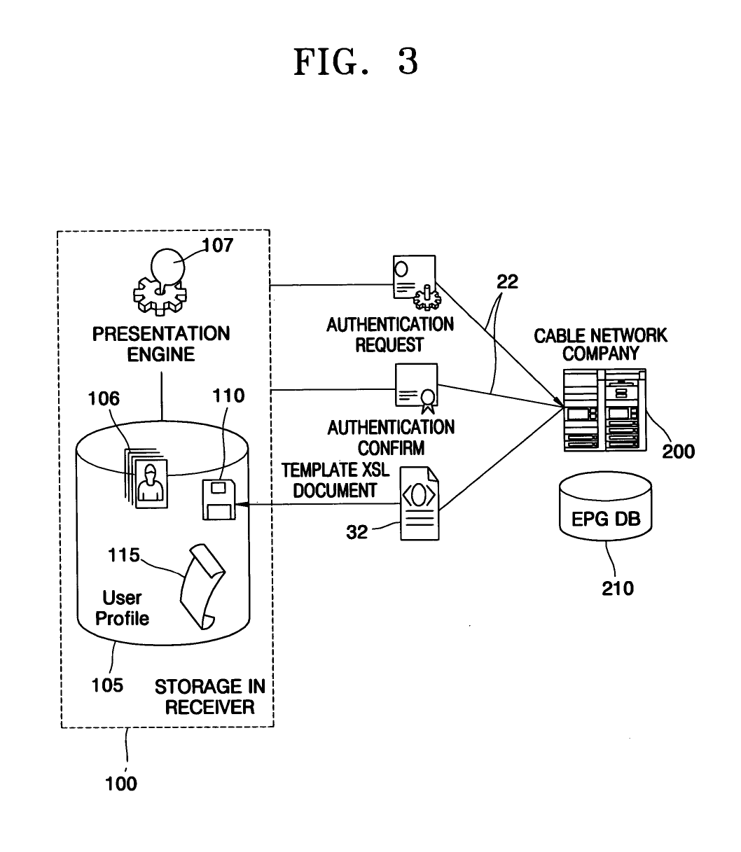

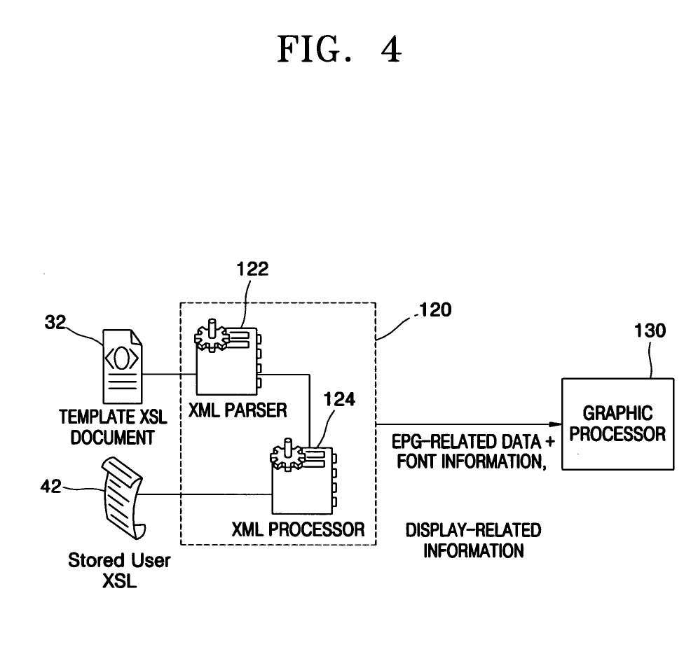

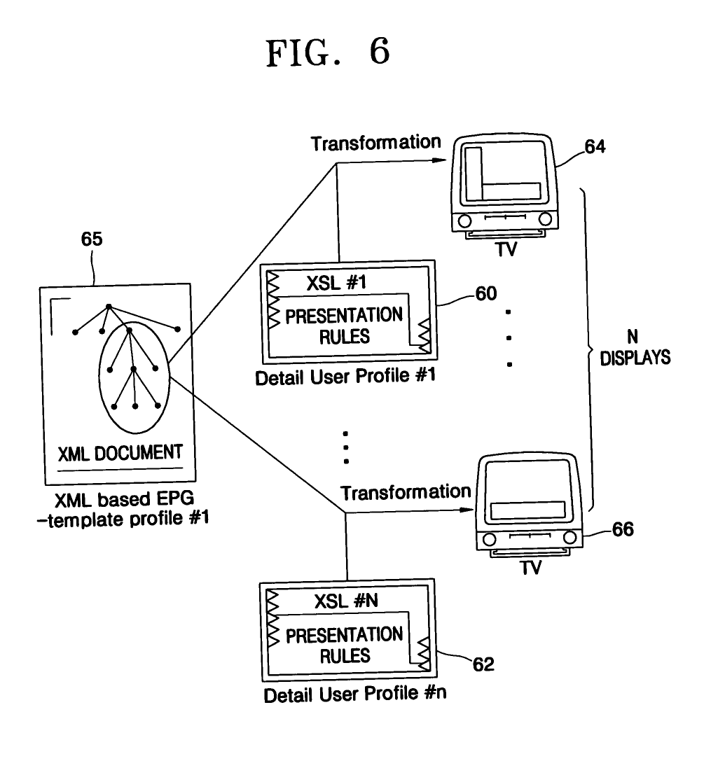

As described above, a user downloads a preferred XML-based EPG template 32 (hereinafter referred to as XML template document 32) through an authentication process 22 of a server from an EPG database 210 of a cable network company 200 to a middle-ware 110 of a storage unit 105 in a receiver 100. The receiver 100 conducts a search for an XSL document 42 to be applied to the XML template document 32 inside the system, and if there is no XSL document 42 in the system, the receiver 100 downloads an XSL document 42 provided by the cable network company 200. A user's profile 106 formed in the receiver 100 is processed by a presentation engine 107 of FIG. 2 or 3, or a graphics processor 130 of FIG. 4, and is displayed on a display 64 or 66 of FIG. 6 connected to the receiver 100.

As shown in FIG. 4, an XML parser 122 in a data analysis processor 120 within the receiver 100 parses the XSL template document 32, and transfers both EPG-related data and display-related information which are extracted through an XSL processor 124 together with an XSL document to be applied, to the graphics processor 130. The user can peruse an EPG list selected through the above-described process.

A second step (Phase 2) of the EPG perusal using the stored XSL document 42 will be described below.

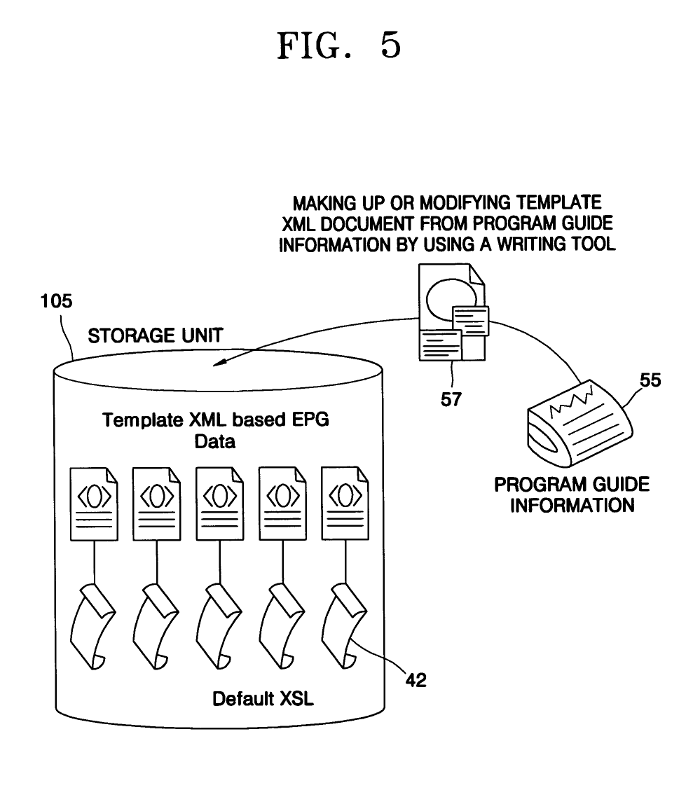

As shown in FIG. 5, in the present invention, an XML-based EPG template is made up of program guide information 55, by using a user interface (Ul) or a simple tool 57 provided by a cable network company, and is stored in a storage unit 105 in the receiver 100. Then, a program can be added or deleted by using the XSL document stored in the receiver 100 or the XSL document 42 downloaded from the cable network company. Then, the addition or deletion result is reflected in the XSL document, and is stored in the storage unit 105 within the receiver 100 as a user defined XSL document 115.

As shown in FIG. 3, a list matching a user's preferences can be viewed using the stored XSL document 115, without modification of the EPG-related document provided by the cable network company 200. The XML template document 32 transmitted by the cable network company 200 is converted by the stored XSL document 32 and displayed on a display screen. Here, each viewer can store each of XSL documents 60 and 62 as shown in FIG. 6, and construct his or her own screen through a selection process from the XML template document 32 when retrieving an EPG program, to thereby display the constructed screen on a display 64 or 66.

As described above, in a method for transmitting an extensible markup language (XML)-based EPG template for a user-preference program guide and a reception device thereof, according to an embodiment of the present invention, a user can select his or her preferred list, without having to search through programs one-by-one, by using a variety of XML-based EPG templates provided by a cable network company. Also, since the created XML template document can be re-constructed as a new list through an extensible path (XPath), a cable network company can avoid the burdensome process of constructing an EPG database in order to create new lists.

Also, a user displays his or her desired contents through XSL conversion. Thus, several users using the same receiver can each construct their own individual desired list and an individual desired screen pattern by using a storing process in the receiver. For this purpose, an XSL processor is constructed by software in a receiver, and a graphics engine capable of processing the XSL document to be displayed on a screen is installed in the present invention. As a result, the present invention makes digital broadcasting more convenient for cable network companies (or program guide producers) and receiver users.

Although the present invention has been described with reference to certain embodiments thereof, it will be apparent to one of ordinary skill in the art that various modifications may be made therein without departing from the scope of the invention as defined by the appended claims.

What is claimed is:

1. A method for transmitting a program guide, comprising the steps of:
converting an extensible markup language (XML)-based electronic program guide (EPG) into an XML-based EPG template for a user's preferred program guide at a cable network company; and
transmitting the XML-based EPG template to a receiver.

2. The transmission method of claim 1, wherein the cable network company provides a style form related to the XML-based EPG template for the receiver, through conversion into an extensible stylesheet language (XSL) document.

3. The transmission method of claim 2, wherein the receiver stores and analyzes the XSL document related to the XML template document.

4. A reception apparatus that receives a program guide transmitted from a cable network company, the reception apparatus comprising:
a storage unit that stores an extensible markup language (XML)-based electronic program guide (EPG) template document for a user's preferred program guide which has been converted and transmitted from a cable network company; and
an XML parser that parses the stored XML-based EPG template document; a graphics processor for graphically processing the parsed XML document and displaying the graphically processed result on a display.

5. The reception apparatus of claim 4, further comprising: a storage unit that stores an extensible stylesheet language (XSL) document related to the XML-based EPG template document; and
an XSL processor that processes the stored XSL document.

6. The reception apparatus of claim 5, wherein the graphics processor processes the parsed XML-based EPG template document and the XSL document so that extracted EPG-related data and display-related information is displayed on the display.

7. The reception apparatus of claim 5, further comprising a storage unit that stores and manages various XSL documents defined by a user which are related to the same XML-based EPG template document.

8. A method of providing an electronic program guide (EPG) that allows for selecting a program without having to scroll through the entire EPG, the method comprising:
providing an extensible markup language (XML) based EPG template;
providing an extensible stylesheet language (XSL) based EPG template;
transmitting the XSL based EPG template and the XML based EPG template to a receiver; and
decoding the XML based EPG template by using the XSL based EPG template to provide an XSL document.

9. The method of claim 8, further comprising:
editing the XML based EPG template by using the XSL based EPG template to provide desired programming for the XSL document.

10. The method of claim 9, wherein the step of editing comprises adding or deleting programming from the XML based EPG template.

11. The method of claim 8, further comprising:
displaying contents of the XSL document on a screen.

12. The method of claim 8, further comprising:
merging the XML based EPG template via the XSL based EPG template and a single path tree to access a node in the XML based EPG template.

13. The method of claim 8, wherein the XSL document is user specific.

14. The method of claim 8, wherein the XML based EPG template includes a program feature and a viewer feature.

15. The method of claim 14, wherein the program feature comprises a program start time, a program end time, a program title and a program type.

16. The method of claim 14, wherein the viewer feature includes an age group, type of program and viewing times.
